(19) United States
(12) Patent Application Publication
(10) Pub. No.: US 2017/0344478 A1
(43) Pub. Date: Nov. 30, 2017

(54) STORING LOG RECORDS IN A NON-VOLATILE MEMORY

(71) Applicant: HUA ZHONG UNIVERSITY OF SCIENCE TECHNOLOGY, Wuhan, Hubei (CN)

(72) Inventors: Dan Feng, Wuhan, Hubei (CN); Binbing Hou, Wuhan, Hubei (CN); Jianxi Chen, Wuhan, Hubei (CN); Lingfang Zeng, Wuhan, Hubei (CN); Wei Tong, Wuhan, Hubei (CN)

(73) Assignee: HUA ZHONG UNIVERSITY OF SCIENCE TECHNOLOGY, Wuhan, Hubei (CN)

(21) Appl. No.: 15/537,274

(22) PCT Filed: Dec. 18, 2014
(86) PCT No.: PCT/CN2014/094183

§ 371 Date: Jun. 16, 2017

(51) Int. Cl. G06F 12/0815; G06F 9/46; G06F 12/02

(52) U.S. Cl. CPC G06F 12/0815; G06F 12/0253; G06F 9/467; G06F 2212/621; G06F 2212/60

(57) ABSTRACT

Technologies are generally described herein for storing log records in non-volatile memory. Transaction data may be accessed that is associated with one or more transactions that modify a data storage device. The transaction data may be stored in a cache that is coupled to the data storage device. The log records corresponding to transaction data may also be stood in a non-volatile memory (NVM) that is coupled to the data storage device. Log records may be synchronized with the data storage device.

### BACKGROUND

Unless otherwise indicated herein, the materials described in this section are not prior art to the claims of this application and are not admitted to be prior art by inclusion in this section.

When to file is modified or stored on a file system, not only may the data of the file be written to the file system but also metadata that describes information about the file may be written to the file system. The metadata about a file may include information such as the location of the file, the author of the file, create time of the file, modify time of the file, size of the file, and the like.

When as write operation is executed to a file system, some data blocks, including the data and metadata, of the file may be modified and/or created. The process of modification and/or creation of these data blocks is an indivisible integrity. Stated another way, either all of the operations of the modification and/or creation process should occur or none of the operations should occur. In order to redo the modification and/or creation process (e.g., in the ease that the process is interrupted by power failure or software error), a log that includes log records may be used to redo the modification and/or creation process.

Writing each of these log records to a disk, however, might negatively affect the performance of a file system. For example, writing a log record to a disk before performing the associated transaction may cause the file system to drop below an acceptable level of performance/efficiency and to seem slow to respond to user input.

In an attempt to improve the performance of the file system, transaction data relating to one or more transactions may be cached in a volatile memory before being written to the to on the disk. Any transaction data that are in the cache, however, may be lost when the system crashes. The longer the time between writing the transaction data from the cache to the disk, the more data that might be lost when the system crashes. Shortening the time between writing the transaction data from the cache to the disk, however, may result in frequent log wiles that may negatively affect the system performance.

Writing all of these log records may also result in a large to file being stored on the disk. For example, a log, may include multiple copies of the same data block. Using this large log for system recovery may result in a longer system recovery time as compared to using a smaller log. For example, locating the copy of the block to use during a system recovery operation from the multiple copies of the block can be difficult. Efficiently writing log records to a data storage device without significantly affecting the system performance can be very challenging.

### SUMMARY

In one example, a method to store log records is described. The method includes accessing transaction data associated with one or more transactions that modify a data storage device. At least a portion of the transaction data may be stored in a cache that is coupled to the data storage device. Log records associated with the transaction data may also be stored in non-volatile memory (“NVM”) that is coupled to the data storage device One or more of the log records or the transaction data obtained from at least one of the cache or the NVM may be synchronized with the data storage device.

In another example, a computer-readable storage medium is described. The computer-readable storage medium comprises computer-executable instructions stored thereon which, in response to execution by a computer, cause the computer to perform one or more methods described herein.

In a further example, a system is described. The system may include a memory bus, a volatile memory, a non-volatile memory and a controller that may be coupled to the memory bus. The controller may be configured to store transaction data in the volatile memory. The transaction data may include data and metadata for one or more transactions that modify a data storage device. The controller may also be configured to store one or more log records in the NVM and to synchronize the one or more log records with a data storage device.

In a further example, an apparatus is described. The apparatus may include a controller. The controller may be operative to store transaction data in a volatile memory that are associated with one or more transactions that modify a data storage device. The controller may also be configured to store the one or more log records in the NVM. The one or more log records may be associated with at least a portion of the transaction data. The controller may also synchronize the one or more log records with the data storage device.

The foregoing Summary is illustrative only and is not intended to be in any way limiting. In addition to the illustrative aspects, embodiments, and features described above, further aspects, embodiments, and features will become apparent by reference to the Figures and the following Detailed Description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is an illustration of a log storage system that is operative to store log records and synchronize log records with a data storage device;

FIG. 2 is an illustration of a log storage system that is operative to store log records and includes a garbage collector component and a system recovery component;

FIG. 3 is a flow diagram illustrating a process to store log records in a non-volatile memory;

FIG. 4 is a flow diagram illustrating a process to perform garbage collection; and

FIG. 5 is diagram illustrating an example computing device that is arranged to implement technologies to store transaction data in a cache and log records in a non-volatile memory,

all arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented herein.

The aspects of the present disclosure, as generally described herein, and illustrated in the figures, can be arranged, substituted, combined, separated, and designed in a wide variety of different configurations, all of which are explicitly contemplated herein. Further, one or more components of various figures described below may not be included in the figure for purposes of clarity. This should not be construed as a disclaimer or admission that the non-included components do not form part of the subject matter described herein. Additionally, one or more figures may use a “dashed” line as a border to visually encapsulate one or more components. Unless specifically described otherwise, the use of a dashed line is for purposes of illustration and does not reflect functional or physical boundaries.

This disclosure is drawn, inter alia, to technologies used to store log records. Log records may be created from transaction data and stored in a non-volatile memory that are coupled to a memory bus before the log records are synchronized to a data storage device (e.g., a magnetic hard disk). The technologies used to store the log records described herein may be directed at reducing the frequency and/or duration of synchronizing the log records with the data storage device.

As discussed, log records may be created from different transactions associated with modification of a file system. For example, log records might he created from transactions that modify a data storage device (e.g., write operations, move operations, delete operations). In some examples, a log record may be created from transaction data and written to a non-volatile memory that are coupled to a memory bus before the file system is altered. Writing to memory that is coupled to a memory bus may be generally much faster as compared to writing to a data storage device that is not connected to the memory bus.

Instead of writing transaction data to a cache and then synchronizing the cache with the data storage device as performed by some logging mechanisms, the transaction data may be used to create log records that may be written to a non-volatile memory (NVM) before the transaction data are synchronized with the data storage device. In some examples, the NVM may be configured to act as a non-violate mirror of the cache. For example the NVM may include a copy of the transaction data stored in the cache.

When the transaction data are stored in the cache, the corresponding log records may also be stored in the NVM at the same time (or shortly thereafter). In this case, even when the system crashes, the loss of the data caused by not synchronizing the transaction data with the data storage device may be reduced since the data is stored in the NVM in addition to the cache.

Different mechanisms may be used to synchronize the data storage device with the transaction data and/or log records that are stored in the cache and/or the NVM. In some examples, transaction data from the cache and/or log records from the NVM may be synchronized with the data storage device in response to the available memory space of the cache or the NVM dropping below a specified threshold, in other examples, transaction data from the cache and/or log records from the NVM may be synchronized with the data storage device in response to the occurrence of some other event.

In some examples, log records that are not related to portions of the data storage device that are frequently Changing (e.g., “cold” log records) may be synchronized with the data storage device before log records that are related to portions of the data storage device that are changing frequently (e.g., “hot” log records). Synchronizing the cold log records to the data storage device may help to maintain the hot transaction data in the cache and the NVM as long as possible.

The log, records within the NVM might also be organized for easier access to valid log records. For example, valid log records may be linked together in a contiguous log space and/or logically moved to arrange the log records in a contiguous log space. The valid log records might also be placed in the log before or after the invalid log records. When the log records are synchronized with the log on the data storage device, the valid log records might be more easily accessed and synchronized with the data storage device.

As used herein, the term “valid log record” may refer to a log record that is to be synchronized with the data storage device (e.g., has not been synchronized with the data storage device and has not been marked “invalid”). The term “invalid log record” may refer to a log record that does not need to be synchronized with the data storage device. For example, a log record in the NVM may be marked invalid after the log record or the corresponding transaction data is synchronized with the data storage device or when a current transaction changes a same memory location of a previous transaction.

Garbage collection might also be performed to free up memory in the cache or the NVM. For example, garbage collection may be performed periodically (or otherwise repeatedly) or in response to some other event to remove the invalid log records from the cache or from the NVM. In some examples, garbage collection may be performed in response to the valid log records being synchronized with the data storage device.

Once the log records are written to the NVM, the NVM may be used during system recovery. For example, the log records may be restored directly from NVM instead of having to obtain the data from the data storage device (e.g., a slower access device). In contrast, some logging mechanisms may first read log data from the data storage device into the memory of the system and may then use that information for system recovery. More details regarding storing log records are provided below.

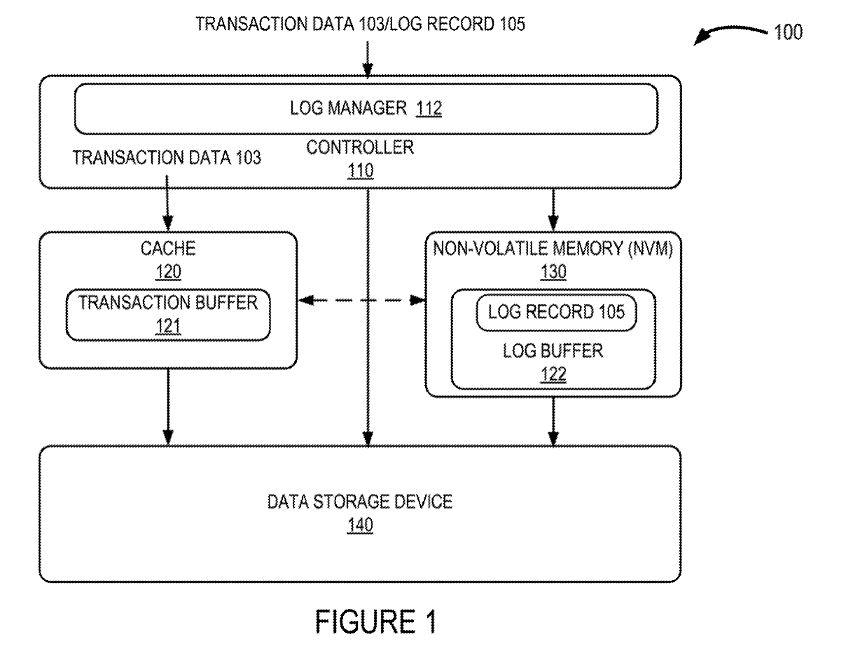

FIG. 1 is an illustration of a log storage system 100 that is operative to store log records and synchronize log records with a data storage device, in accordance with at least some embodiments. As illustrated, the log storage system 100 may include a controller 110, one or more caches 120, one or more non-volatile memories 130, and a data storage device 140. The controller 110 may include a log manager 112. The cache 120 may include a transaction buffer 121 and the NVM 130 may include a log buffer 122.

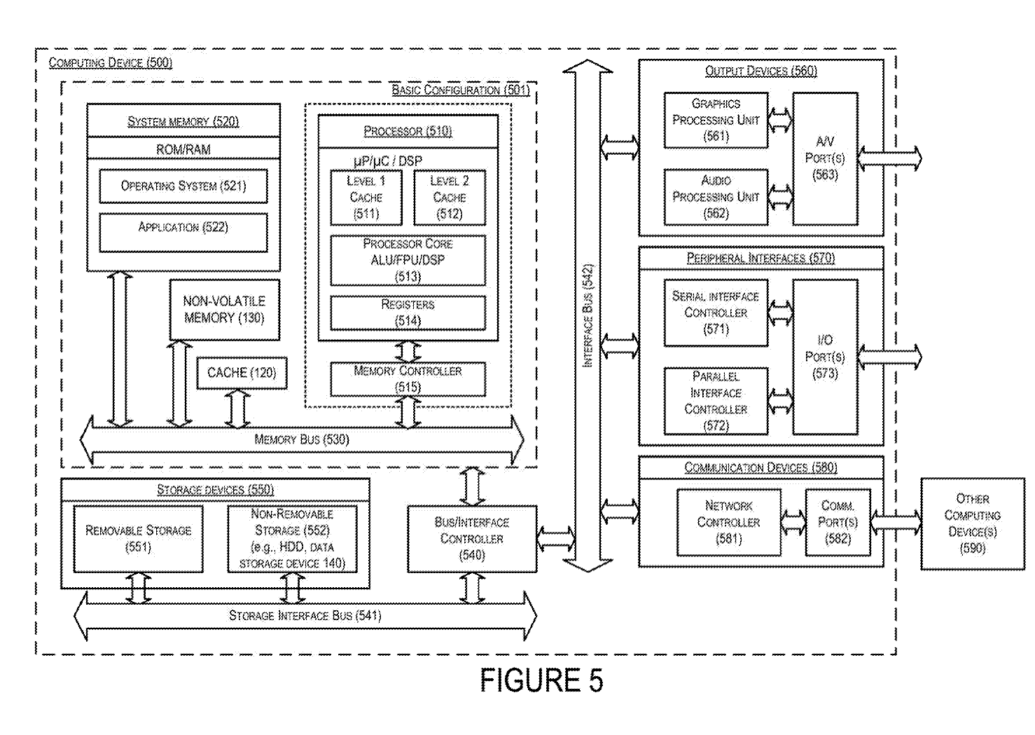

The components of the log storage system 100 may be part of one or more components of a computing device or system. The composition, use and location of the components of log storage system 100 may vary from application to application. For example, the cache 120 and the NVM 130 may be stored within or comprise part of the system memory 520 of a computing device 500 as illustrated in FIG. 5.

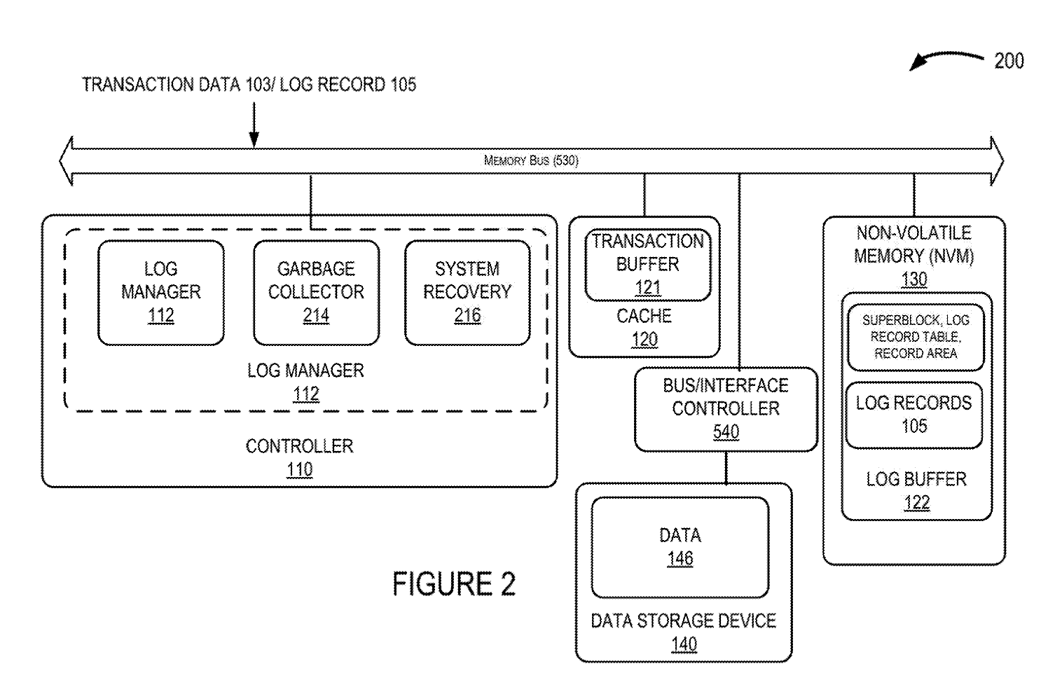

As illustrated, the controller 110 may be coupled to the cache 120 and the NVM 130. In some examples, a memory bus, such as the memory bus 530 shown in FIGS. 2 and 5, may couple the cache 120, the NVM 130 and the controller 110 (See FIG. 2). The data storage device 140 may be coupled to the controller 110, the cache 120 and/or to the NVM 130. In some examples, the data storage device 140 may be coupled to the memory bus 530 via a bus/interface controller 540 as shown in FIG. 5. Generally, interactions, such as read and write operations, with the data storage device 140 may be much slower as compared to similar interactions with the cache 120 and the NVM 130.

Typically, a cache, such as the cache 20, may be a small, fast memory that may be used to store frequently used, recently used, or soon to be used, blocks of data for rapid access. In many examples, the size of the cache 120 may be smaller as compared to the size of the data storage device 140. The cache 120 may include volatile, memory and/or non-volatile memory. In, some examples, the cache 120 may include volatile memory, such as random access memory (RAM).

The transaction buffer 121 of the cache 120 may be configured to store transaction data 103 related to transactions of the data storage device. The transaction data may include modified data and/or modified metadata associated with one or more transactions. For example, the cache may include data relating to a transaction that may be stored in log records, such as log record 105. As discussed above, transaction data 103 relating to transactions that modify the data storage device 140 may be temporarily stored in the one or more caches 120 and the one or more non-volatile memories 130. The use of the cache 120 to store transaction data 103 and the NVM 130 to store log records 105 may reduce the frequency of the writes of log records to the data storage device 140.

The NVM 130 may include one or more non-volatile memories. Generally, the larger the number of non-volatile memories 130, the better the performance of the memory. For example, when multiple non-.volatile memories 130 operate in parallel, the bandwidth may scale and the high latencies that might be associated with non-volatile memories might be lowered.

Many different types of non-volatile memory may be used within the tog storage system 100. In some examples, the NVM 130 may include a byte addressable non-volatile memory, such as phase change memory or memristor. The NVM 130 might be NOR flash memory, static random-access memory (“SRAM”), magnetoresistive random-access memory (“MRAM”), or some other type of non-volatile memory might be used. In some examples, the size of the NVM 130 may be at least the same size as the available memory of the cache 120.

The controller 110 may be configured to perform operations relating to storing transaction data 103 and log records 105. In some examples, the controller 110 may be embodied as an embedded processor or other type of processor. The controller 110 might include more or fewer components as illustrated. For example, the controller 110 might include a garbage collector 214 and a system recovery component 216 as illustrated in FIG. 2.

In operation, the log manager 112 may be configured to store the transaction data 103 relating to the transactions involving the data storage device 140 in the cache 120 and to store the associated log records 103 in the NVM 130. In some examples, the transaction data and log records may be the same data. As discussed above, transactions that modify the data storage device 140 might be write operations, move operations, delete operations, and/or other operations.

In some examples, the log manager 112 may store the transaction data 103 in the cache 120 and the log record 105 in the NVM 130 before the log record 105 is synchronized with the data storage device 140. The log manager 112 may be configured to store the log record 105 in the NVM 130 at the same time or near in time to the time the transaction data 103 is stored in the cache 120. In some examples, the transaction data 103 that is stored in the cache 120 and the log record 105 stored in the NVM 130 may include the same data. In other words, the NVM 130 may be configured to act as anon-volatile mirror of the cache 120. In other examples, the transaction data 103 and the corresponding log record 105 might be slightly different.

The log manager 112 might employ one or more mechanisms to synchronize the transaction data 103 maintained by, the cache 120 and/or the log records 105 maintained by the NVM 130 with the data storage device 140. In some examples, the log manager 112 may be configured to synchronize the data storage device 140 with the transaction data 103 from the cache 120 and/or the log records 105 stored by the NVM 130 in response to the available memory space of the cache 120 or the NVM 130 dropping below a specified threshold. For example, the specified threshold might be a percentage of available storage space e.g., 20%, 30%) or might be a hard limit (e.g., 500 MB). In other examples, log records may be synchronized with the data storage device 140 by the log manager 112 in response to an occurrence of some other event.

In some examples, the log manager 112 and/or the controller 110 may be configured to identify log records within the log buffer 122 that are cold log records. The cold log records may be synchronized with the data storage device 140 by the log manager 112 before log records that are identified as hot log records.

The log manager 112 might also be configured to organize the log records, For example, the log manager 112 may be configured to group the valid log records together for more efficient access to the valid log records. In some examples, the log manager 112 may link valid log records together in a contiguous physical log space or contiguous virtual log space (e.g., linked valid log records). The valid log records might also be placed in the log buffer 122 before or after the invalid log records.

As discussed in more detail below, garbage collection and system recovery may also be preformed by the controller 110. For example, garbage collection may be performed to remove the invalid log records from the NVM 130. In some examples, when the log manager 112 determines that more memory space is still needed after garbage collection performed by the garbage collector 214, all or a portion of the log records stored in the non-volatile memory 130 may be synchronized of the data storage device 140. The controller 110 might also access valid log records in the NVM 130 when performing system recovery operations. More details regarding storing log records are provided below.

FIG. 2 is an illustration of a log storage system 200 that is operative to store log records in a NVM and includes a garbage collector component and a system recovery component, in accordance with at least some embodiments. The log storage system 200 may be similar to the log storage system 100 as illustrated in FIG. 1 (and so may identify analogous components with the same reference labels/numbers) but may include more components. As illustrated, the log storage system 200 may include a controller 110, one or more caches 120, one or more non-volatile memories 130, a bus/interface controller 540, a data storage device 140, and a memory bus 530. The controller 110 may include a log manager 112, a garbage collector 214 and a system recovery component 216. In some examples, the log manager 112 may include the garbage collector 214 and the system recovery component 216, and hence this embodiment is depicted with broken lines in FIG. 2. The cache 120 may include a transaction buffer 121. The data storage device 140 may include data 146. The NVM 130 may include log buffer 122.

As illustrated, the controller 110, the cache 120, the NVM 130 and the bus/interface controller 540 may be coupled via the memory bus 530. The log storage system 200 may also include the data storage device 140 that may be coupled to the memory bus 530 via the bus/interface controller 540. The data storage device 140 may be coupled to the bus/interface controller 540.

As discussed above, the transaction buffer 121 and the log buffer 122 may be configured to store data (e.g., the transaction data 103 and the log record 105) that relate to various transactions of the file system with the data storage device 140. In sonic examples and as shown in FIG. 2, the log buffer 122 might also include a superblock, a log record table and a log record area. According to some configurations, the superblock records information about the log records 105 that are stored in the log area.

The log buffer 122 might also be used to store other information relating to the log records. For example, the log buffer 122 might store information, such as, but not limited to log volume, residual space, the start position of the log record, the end position of the previous transaction, the end position of the current transaction, and/or other information within the superblock of the log buffer 122. The information might also include the latest position of the log's recording of the disk block; the log recording area may be used tier depositing, log records. In some examples, the log records, such as the log record 105, may be deposited in sequence (e.g., the order in which the transactions occur within a computing system) within the buffer area (e.g., transaction buffer 121 and/or log buffer 122).

As also discussed above, the log manager 112 may be configured to perform various operations such as writing a log record, such as the log record 105, to the log buffer 122 of the NVM 130 and writing the transaction data 103 to the transaction buffer 121 of the cache 120. In some examples, the controller 110 may be configured to store the transaction data 103 to the cache 120 before performing the transaction (e.g., before performing a write operation) to the data storage device 140. In other examples, the controller 110 may write the transaction data 103 to the cache 120 and the corresponding log record 105 to the NVM 130 before performing the transaction. In other examples, the controller 110 may write the transaction data 103 to the cache before writing the log, record 105 to the NVM 130.

The log manager 112 may also be configured to identify log records that are already stored in the NVM 130 that are no longer valid. A log record 105 might be determined to be invalid for a variety of different reasons. In some examples, a log record 105 may be determined to be invalid by the log manager 112 when the current transaction is modifying a same location as identified by a previous transaction. In other examples, a log record 105 may be marked invalid by the log manager 112 in response to the log record 105 being synchronized with the data storage device 140. As discussed above, the log records may be stored using different mechanisms. In sonic examples, the log records may be sequentially stored using a linked list. For example, the end position of one log record may point to the start position of the next log record. In some examples, the valid log records are ordered sequentially within the NVM.

The garbage collector 214 may be configured to perform garbage collection. As discussed above, garbage collection might be performed to free up memory. In some examples, the garbage collector 214 may be configured to remove invalid log records from the NVM 130. The garbage collector 214 may be configured to perform garbage collection periodically (or otherwise repeatedly) and/or in response to an occurrence of a specified event. For example, the garbage collector 214 might be configured to perform garbage collection when the available memory space in log buffer 122 falls below a specified threshold. In other examples, the garbage collector 214 may be configured to perform garbage collection according to one or more schedules (e.g., each ten minutes, hourly, etc).

The system recovery component 216 may be configured to perform operations relating to system recovery for the data storage device 140. In some examples, the system recovery component 216 may access valid log records from the log buffer 122 of the NVM 130 and synchronizes them the data storage device 140. During system recovery, the system recovery component 216 component may be configured to use valid log records obtained from the NVM 130.

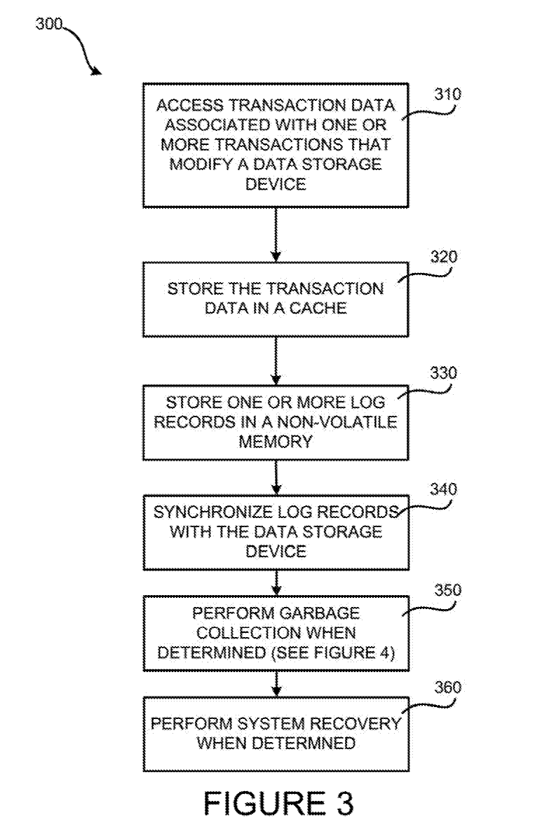

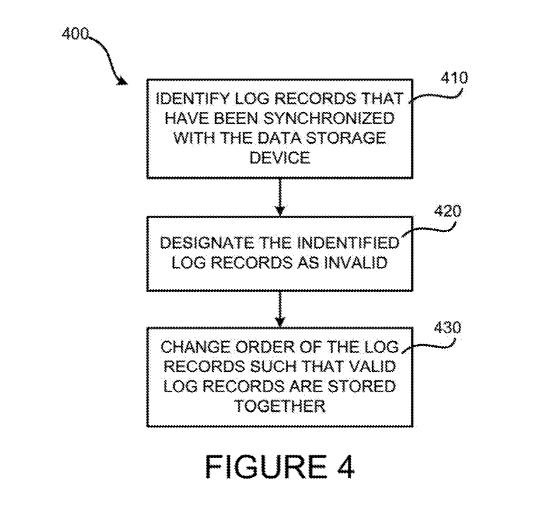

FIGS. 3-4 are flow diagrams respectively illustrating example processes to store log information in a cache and non-volatile memory and to perform garbage collection, in accordance with at least some embodiments described herein. The operations of any process described herein are not necessarily presented in any particular order and that performance of some or all of the operations in an alternative order(s) is possible and is contemplated. The operations have been presented in the demonstrated order for ease of description and illustration. Operations may be added, combined, modified, omitted, and/or performed simultaneously, in a different order, etc., without departing from the scope of the present disclosure.

The illustrated processes can be ended at any time and need not be performed in its entirety. Some or all operations of the processes, and/or substantially equivalent operations, can be performed by execution of computer-readable instructions included on a computer storage media, as defined herein, including a tangible non-transitory computer-readable storage medium. The term “computer-readable instructions,” and variants thereof, as used in the description and claims, is used expansively herein to include routines, applications, application modules, program modules, programs, components, data structures, algorithms, or the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, or the like. For purposes of illustrating and describing the concepts of the present disclosure, the processes 300 and 400 is described as being performed, at least in part, by one or more components of the computing device 500 of FIG. 5. This embodiment is illustrative, and the processes may be performed in other ways using other device(s) or component(s) thereof.

FIG. 3 is a flow diagram illustrating a process to store log records in a non-volatile memory, in accordance with at least some at least some embodiments described herein. The process 300 may begin at block 310 (“access transaction data associated with one or more transactions that modify a data storage device”), where transaction data are accessed. As discussed above, transaction data that may include modified data and/or metadata associated with one or more transactions that modify a data storage device. For example, a controller 110 might access transaction data 103 that is associated with a transaction that modifies the data storage device 140.

The process 300 may continue to block 320 (“store the transaction data in a cache”), where the transaction data may be stored in a cache. As discussed above, the controller 110 may be configured to store the transaction data 103 in the cache 120 that is coupled to the memory bus 530.

The process 300 may continue to block 330 (“store one or more log records in a non-volatile memory”), where the one or more log records may be stored in a non-volatile memory. As discussed above, the controller 110 may be configured to generate the log, records 105 from, the transaction data 103 and to store the one or more log records in the non-volatile memory 130 that is coupled to the memory bus 530. According to some configurations the transaction data 103 and the corresponding log record 105 may include the same data. In some examples, the non-volatile memory 130 may be byte addressable.

The process 300 may continue to block 340 (“synchronize log records with the data storage device”), where log records may be synchronized with the data storage device 140. As discussed above, the controller 110 may be configured to synchronize the log records stored in the NVM with the data storage device 140. In some examples, the controller 110 may obtain transaction data 103 from the cache 120 to generate the log records and/or obtain the log records from the non-volatile memory 130.

The process 300 may continue to block 350 (“persons garbage collection when determined”), where garbage collection may be performed when determined. As discussed above, the controller 110 may be configured to perform garbage collection periodically (and/or otherwise repeatedly) and/or in response to different events. In some examples, the controller 110 may perform garbage collection in response to an available space of the cache 120 and/or the NVM 130 falling below a specified threshold. FIG. 4 provides more details regarding garbage collection, in accordance with aspects of the present disclosure.

The process 300 may continue to block 350 (“perform system recovery when determined”), where system recovery may be performed when determined. As discussed above, the controller 110 may be configured to obtain log records directly from the non-volatile memory 130 when performing a system recovery. The process 300 may thereafter end or return to perform some other operation. For example, the process 300 might return to block 310.

FIG. 4 is a flow diagram illustrating a process to perform garbage collection, in accordance with at least some embodiments. The process 400 may begin at block 410 (“identify log records that have been synchronized with the data storage device”), where log records that have been synchronized with the data storage device are identified. As discussed above, the controller 110 and/or the garbage collector 214 may be configured to identity the log records that have been synchronized with the data storage device 140.

The process 400 may continue to block 420 (“designate the identified log records are invalid”), the identified log records may be identified as invalid. As discussed above, the garbage collector 214 may be configured to mark the identified log records in the non-volatile memory 130 that have been stored in the data storage device 130 as invalid. The log records that are not marked as “invalid” are “valid” log records that have not yet been synchronized with the data storage device 140.

The process 400 may continue to block 430 (“change order of the log records such that valid log records are stored together”), the valid log records may be stored together. As discussed above, the garbage collector 214 may be configured to re-order the valid log records within the non-volatile memory 130 such that the valid log records are stored contiguously within the with volatile memory 130. The process 400 may thereafter end.

FIG. 5 is a block diagram illustrating an example computing device 500 that is arranged to implement technologies to store transaction data in a cache and log records in a non-volatile memory, arranged in accordance with at least some embodiments described herein. In a very basic configuration 501, computing device 500 typically includes one or more processors 510 and system memory 520. A memory bus 530 can be used for communicating between the processor 510 and the system memory 520.

Depending on the desired configuration, processor 510 can be of any type including, but riot limited to, a microprocessor (“μRP”), a microcontroller (“μMC”), a digital signal processor (“DSP”), or any combination thereof. Processor 510 can include one more levels of caching, such as a level one cache 511 and a level two cache 512, a processor core 513, and registers 514. The processor core 513 can 1include an arithmetic logic unit (“ALU”), a floating point unit (“FPU”), a digital signal processing core (“DSP Core”), or any combination thereof. A memory controller 515 can also be used with the processor 510, or in some implementations the memory controller 515 can be an internal part of the processor 510. The processor 510 can be a multi-core processor having two or more independent processing units (“cores”). In some embodiments, the processor 510 can be used to implement the controller 110 described above.

Depending on the desired configuration, the system memory 520 can be of any type including, but not limited to, volatile memory (such as RAM), non-volatile memory (such as ROM, flash memory, etc.) or any combination thereof. One or more components of the system memory 520 may be comprised of multilevel cells formed from GST material, providing a phase change memory. System memory 520 typically includes an operating system 521 and one or more applications 522. In some embodiments, the data storage device 140 may be implemented as part of the system memory 520.

Non-volatile memory 130, as discussed above, may be configured to store log records 105 relating to transactions involving a storage device, such as a data storage device 140. Cache 120, as also discussed above, may be configured to store transaction data relating to the transactions involving the storage device. In some embodiments, the cache 120 can be implemented in either or both caches 511 and 512.

Computing device 500 can have additional features or functionality, and additional interfaces to facilitate communications between the basic configuration 501 and any required devices and interfaces. For example, a bus/interface controller 540 can be used to facilitate communications between the basic configuration 501 and one or more data storage devices 550 via a storage interface bus 541. The data storage devices 550 can be removable storage, devices 551, non-removable storage devices 552, or a combination thereof. In some embodiments, the data storage device 140 can be implemented by the one or more data storage devices 550. Examples of removable storage and non-removable storage devices include magnetic disk devices such as flexible disk drives and hard-disk drives (“HDD”s), and solid state drives (“SSD”s), to name a few. Example computer storage media can include volatile and nonvolatile, removable and non-removable media implemented in,any method or technology for storage of information, such as computer readable instructions, data structures, program modules, or other data.

System memory 520, removable storage devices 551 and non-removable storage devices 552 are all examples of computer storage media. Computer storage media includes, but is not limited to, RAM, ROM, EEPROM, flash memory or other memory technology, magnetic disk storage or other magnetic storage devices, or any other medium which can be used to store the desired information and which can be accessed by computing device 500. Any such computer storage media can be part of the computing device 500.

Computing device 500 can also include an interface bus 542 for facilitating communication from various interface devices (e.g., output interfaces, peripheral interfaces, and communication interfaces) to the basic configuration 501 via the bus/interface controller 540. Example output devices 560 include a graphics processing unit 561 and an audio processing unit 562, which can be configured to communicate to various external devices such as a display or speakers via one or more A/V ports 563. The example peripheral interfaces 570 include a serial interface controller 571 or a parallel interface controller 572, which can be configured to communicate with external devices such as input devices (e.g., keyboard, mouse, pen, voice input device, touch input device, etc.) or other peripheral devices (e.g., printer, scanner, etc.) via one or mare I/O ports 573. An example communication device 580 includes a network controller 581, which can be arranged to facilitate communications with one or more other computing devices 590 over a network communication via one or more communication ports 582. The communication connection is one example of a communication media.

Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, communication media can include wired media such as a wired network or direct-wired connection and wireless media such as acoustic, radio frequency (“RF”), infrared (“IR”), Fiber Optics, and other wireless media. The term computer readable media as used herein can include both storage media and communication media.

Computing device 500 can be implemented as a portion of a small-form factor portable (or “mobile”) electronic device such as a cell phone, a personal data assistant (“FDA”), a personal media player device, a wireless web-watch device, a personal headset device, an application specific device, or a hybrid device that include any of the above functions. Computing device 500 can also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible. Such modifications and variations are intended to fall within the scope of the appended claims. The present disclosure is to be limited only by the terms of the appended claims, along with the full scope, of equivalents to which such claims are entitled. This disclosure is not limited to particular methods, compounds, or compositions, which can, of course, vary. The terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e,g., the bare recitation of “two recitations,” without other modifiers, means at least two recitations, or two or more recitations).

Furthermore, in those instances where a convention analogous to “at least one of A, B, and C, etc,” is used, in general such a construction is intended in the sense one having skill in the art would understand the convention (e.g., “a system having at least one of A, B, and C” would include, but not be limited to, systems that have A alone, 13 alone, C alone, A and B together, A and C together, B and C together, and/or A, B, and C together, etc). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

Further, the use or the terms “first,” “second,” “third,” “fourth,” and the like is to distinguish between repeated instances of a component or a step in a process and does not impose a serial or temporal limitation unless specifically stated to require such serial or temporal order.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” or the like include the number recited and refer to ranges which can be subsequently broken down into subranges as discussed above. Finally, as will be understood by one skilled in the art, a range includes each individual member. Thus, for example, a group having 1-3 elements refers to groups having 1, 2, or 3 elements. Similarly, a group having 1-5 elements refers to groups having 1, 2, 3, 4, or 5 elements, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to store log records, the method comprising:
accessing transaction data associated with one or more transactions that modify a data storage device;
storing at least a portion of the transaction data in a cache that is coupled to the data storage device;
storing one or more log records in a non-volatile memory (NVM) that is coupled to the data storage device, wherein the one or more log records are associated with the transaction data, and wherein the non-volatile memory (NVM) is different from the cache; and
synchronizing one or more of the at least the portion of the transaction data or the one or more log records with the data storage device, wherein the at least the portion of the transaction data is obtained from the cache, and wherein the one or more log records are obtained from the NVM.

2. The method of claim 1, further comprising performing garbage collection to identify one or more valid log records, from the one or more log records, stored in the NVM, wherein the one or more valid ion records represent log records that are yet to be synchronized with the data storage device.

3. The method of claim 2, further comprising ordering the valid log records sequentially within the NVM.

4. The media d of claim 2, wherein performing the garbage collection comprises:
identifying log records from the one or more log records stored in the NVM, log records that have been synchronized with the data storage device; and
designating the identified log records as invalid log records in the NVM.

5. The method of claim 1, further comprising performing a system recovery using one or more valid log records stored in the NVM, wherein the one or more valid to records represent log records that are yet to be synchronized with the data storage device.

6. The method of claim 5, wherein performing the system recovery using the one or more valid log records stored in the NVM comprises storing the one or more valid log records in at least one of the cache or the data storage device.

7. The method of claim 1, wherein synchronizing occurs in response to at least one of performing a garbage collection for the NVM or determining that an available memory space for at least one of the cache or the NVM is below a particular threshold.

8. The method of claim 1, further comprising identifying the one or more log records in the NVM as invalid log records, in response to completing the synchronizing of the one or more log records with the data storage device.

9. The method of claim 1 wherein storing the one or more log records in the NVM includes storing, in the NVM, a copy of the at least the portion of the transaction data stored in the cache.

10. A computer-readable storage medium comprising computer-executable instructions stored therein which, in response to execution by a computer, cause the computer to perform the method of claim 1.

11. A system, comprising:
a memory bus;
a volatile memory coupled to the memory bus;
a non-volatile memory (NVM) coupled to the memory bus; and
a controller coupled to the memory bus and operative to:
store transaction data, in the volatile memory, wherein the transaction data comprise data and metadata for one or more transactions that modify a data storage device.
store one or more log records in the NVM, wherein the one or more log records are associated with the transaction data, and
synchronize the one or more log records with the data storage device.

12. The system of claim 11, wherein to synchronize the one or more log records in the data storage device, the controller is operative to:
obtain the one or more log records from the NVM; or
obtain the transaction data from the volatile memory to generate the one or more log records.

13. The system of claim 11, wherein the controller is further operative to perform garbage collection to identify one or more valid log records and one or more invalid log records from the one or more log records stored in the NVM.

14. The system of claim 13, wherein the controller is further operative to arrange the one or more valid log records in a first memory space in the NVM and to arrange the one or more invalid log records in a second memory space in the NVM.

15. The system of claim 11, wherein to synchronize the one or more log records with the data storage device, the controller is operative to determine that a memory usage of at least one of the volatile memory or the NVM is above a particular threshold.

16. The system of claim 11, wherein to synchronize the one or more log records with the data storage devices the controller is operative to periodically synchronize at least one of the one or more log records from the NVM with the data storage device and the transaction data from the volatile memory with the data storage device.

17. The system of claim 11, wherein the controller is further operative to mark the one or more log records in the NVM as invalid log records in response to a determination that the one or more log records have been synchronized with the data storage device.

18. The system of claim 11, wherein the controller is further operative to perform a system recovery, and wherein to perform the system recovery, the controller is operative to store at least a portion of valid log records obtained from the NVM to at least one of the volatile memory or the data storage device.

19. The system of claim 11, wherein the controller is further operative to store one or more log record tables, one or more log superblocks, and one or more log record areas in the NVM.

20. The system of claim 11, wherein the volatile memory includes one or more dynamic random access memories, and wherein the NVM includes one or more non-volatile byte addressable memories.

21. An apparatus, comprising:
a controller operative to:
store transaction data in a volatile memory, wherein the transaction data is associated with one or more transactions that modify a data storage device,
store one or more log records in a non-volatile memory (NVM), wherein the one or more log records are associated with at least a portion of the transaction data, and
synchronize the one or more log records with the data storage device.

22. The apparatus of claim 21, wherein the controller includes:
a log manager configured to store the one or more log records in the NVM;
a garbage collector configured to identify one or more valid log records and one or more invalid log records from the one or more log records stored in the NVM; and
a system recovery component configured to store at least a portion of the one or more valid log records obtained from the NVM to at least one of the volatile memory or the data storage device.

23. The apparatus of claim 21, wherein to synchronize the one or more log records with the data storage device, the controller is operative to:
obtain the one or more log records from the NVM, or
obtain the transaction data from the volatile memory to generate the one or more log records.

24. The apparatus of claim 22, wherein the controller is further operative to arrange the one or more valid log records in a first memory space in the NVM and to arrange the one or more invalid log records in a second memory space in the NVM.

25. The apparatus of claim 21, wherein the controller is further operative to mark the one or more log records in the NVM as invalid in response to a determination that the one or more log records are stored on the data storage device.
